(19) United States
(12) Patent Application Publication
(10) Pub. No.: US 2024/0286942 A1
(43) Pub. Date: Aug. 29, 2024

(54) Method and System for Processing a Fluid

(71) Applicant: Economy AGT Fluid Management Systems, LLC, Houston, TX (US)

(72) Inventor: Paul Englram, Burr Ridge, IL (US)

(21) Appl. No.: 18/115,410

(22) Filed: Feb. 28, 2023

(51) Int. Cl. C02F 9/00

(52) U.S. Cl. CPC C02F 9/00; C02F 1/004; C02F 1/24; C02F 1/40; C02F 1/52; C02F 1/722; C02F 1/76; C02F 2101/203; C02F 2101/32; C02F 2103/10; C02F 2201/005; C02F 2301/024; C02F 2303/16

(57) ABSTRACT

A process for treating a feed fluid in a manner that results in providing a product fluid for a predetermined destination. The process includes the steps of providing the source fluid to a first treatment step, the feed fluid being aqueous and comprising a hydrocarbonaceous constituent present in the range of 100 to 1000 ppm total petroleum hydrocarbon. Prior to the first treatment step, the process injecting a microgas solution into the feed fluid.

### STATEMENT REGARDING FEDERALLY SPONSORED RESEARCH OR DEVELOPMENT

Not applicable.

### BACKGROUND

### Field of the Disclosure

This disclosure relates to systems and methods for processing a fluid. The fluid may be an aqueous-organic waste stream. Particular embodiments pertain to processing a fluid stream in a manner that facilitates the option of recycle and/or disposal. Certain embodiments may pertain to water treatment systems for removal of oil, flocculation, clarification and filtration.

### Background of the Disclosure

The oilfield and other industrial wastewater applications are challenged with oil and solids in the wastewaters. Many devices have been designed to remove these contaminants.

For example, systems have been developed to remove contaminants from water produced during the production of oil and gas or flowback water from fracking operations. Systems have also been developed to treat sea water to remove salts and minerals.

The US Department of Energy (DOE) has called produced water “by far the largest single volume byproduct or waste stream associated with oil and gas production.” The DOE further terms its treatment a serious environmental concern and a significantly growing expense to oil and gas producers.

The world's oil and gas fields produce billions of barrels of water needing processing. In some instances, the amount of water used for fracing is 9:1 to barrels of oil extracted. And the ratio of water to hydrocarbons increases over time as wells become older. That means less oil or gas and more contaminated water as we attempt to meet rising global energy needs.

In order to treat water, conventional systems may utilize cost prohibitive chemistry and equipment, such as that associated with chemically activated dissolved air floatation, electrocoagulation and membrane separation. Expensive at the best of times, this is even more problematic in the era of rampant inflation. Tubular settling is not used for these applications, due to drawbacks associated with rapid plugging from oil and other contaminants.

The produced water is being generated in the field by oil production and the water typically is prepared for disposal by removing a bulk of the oil and suspended solids prior to injecting into a disposal well. The value of oil and the disposal wells sensitivity to solids is demanding for improved technology to provide a high oil and solids removal.

Due to the flexibility required by the oil and gas industry today, systems need to supply recycled water as needed in the location where the water is produced. This may require that water be able to produce the recycled water for shorter duration. Mobilization of systems for shorter duration can be cost prohibitive and reduce the amount of recycled water used in an area. This technology provides a solution which is able to remove the oil and react out the solids from produced water for recycling, but also be able to remove the oil and suspended solids before water is injected into a disposal well when water is not required for recycling.

The produced water is being generated in the field by oil production and to have one system which is able to act as an oil and suspended solids removal before a disposal well and them from a touch at the touch screen be able to convert to process and produce recycled water provided a real advantage. The equipment will already be in place to provide the clean water for efficient disposal well operation or meet the needs of the recycled water requirements. One system without added costs with automation to allow the manpower reduction.

There is a need in the art for new, cost-effective, and safe methods fluid processing. There is a need in the art for systems and methods that may operate at a lower cost, greater contaminant removal efficiency, with lowered risk of danger to operating personnel and with a lower level of manpower.

### SUMMARY

Embodiments herein provide for systems and methods that may operates at a lower cost, greater contaminant removal efficiency, and also reduce or eliminate risk of labor cleaning out the inside of these systems and the down time created by the clean out.

Some embodiments herein may pertain to a process for treating a feed fluid in a manner that results in a product fluid. The process may include a number of steps, such as providing the feed fluid to a first treatment step. The feed fluid may be aqueous in nature, and may have a hydrocarbonaceous constituent present in a range such as 100 to 1000 ppm total petroleum hydrocarbon. the source fluid comprises produced water, wastewater, brine, and combinations thereof.

Prior to the first treatment step, the process may include injecting a gas solution into the feed fluid. The gas solution may be microgas, or gas bubbles with an average bulk diameter of less than 100 microns. The average bulk diameter may be greater than 20 microns.

The process may include treating the feed fluid with the injected gas solution via the first treatment step to produce a first treated stream. In aspects, the process may include providing the first treated stream to a second treatment step.

The first treated stream may be an aqueous stream with 85% to 99% total petroleum hydrocarbon removal from the feed fluid. The first treated stream may have an additive disposed therein, such as an oxidizer.

The second treatment step may result in the product fluid comprising one or more characteristics of: no more than 30 ppm remnant total petroleum hydrocarbon; no more than 5 ppm total remnant iron-based constituent(s); a pH in a pH range of at least 6 to no more than 7.5; and an ORP in the range of at least 200 (+) to no more than 350 (+). In aspects, the first treatment step may include operating a separation unit to provide a bulk fluid residence time of at least 30 minutes to no more than 60 minutes.

The second treatment step may include operating a clarifier with a layer of tubular packing.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1 shows an overview flow diagram of a process for treating a fluid according to embodiments of the disclosure;

FIG. 2A shows an elevation view of a unit operation diagram of a system for treating a fluid according to embodiments of the disclosure;

FIG. 2B shows a side view of the unit operation diagram for the system of FIG. 2A according to embodiments of the disclosure;

FIG. 3A shows a block flow diagram of a front-end portion of a system for treating a fluid according to embodiments of the disclosure;

FIG. 3B shows a flock flow diagram of a back-end portion of the system of FIG. 3A according to embodiments of the disclosure;

FIG. 4A shows a close-up side cross-sectional view of a bed or stage of tubular packing according to embodiments of the disclosure;

FIG. 4B shows a downward lateral cross-sectional view of an example of a tube cell configuration according to embodiments of the disclosure;

FIG. 4C shows a downward lateral cross-sectional view of another example of a tube cell configuration according to embodiments of the disclosure; and

FIG. 5 shows a side view of a system for treating a fluid that utilizes a zeolite filtration process according to embodiments of the disclosure.

### DETAILED DESCRIPTION

Herein disclosed are novel apparatuses, systems, and methods that pertain to treating a feed fluid, details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Various equipment may be in fluid communication directly or indirectly with other equipment. Fluid communication may occur via one or more transfer lines and respective connectors, couplings, valving, and so forth. One or more valves may need to be opened so that respective components transfer into the gun assembly. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

The term “water” as used herein can refer to the main constituent for a frac fluid, and can include fresh water, seawater, produced water, treated variations thereof, mixes thereof, etc., and can further include impurities, dissolved solids, ions, salts, minerals, and so forth. Water for the frac fluid can also be referred to as ‘frac water’.

The term “produced water” as used herein can refer to water recovered from a subterranean formation or other area near the wellbore. Produced water can include ‘flowback water’, which is water recovered from the subterranean formation after a frac operation.

The term “chemical” as used herein can analogously mean or be interchangeable to material, chemical material, ingredient, component, chemical component, element, substance, compound, chemical compound, molecule(s), constituent, and so forth and vice versa. Any ‘chemical’ discussed in the present disclosure need not refer to a 100% pure chemical. For example, although ‘water’ may be thought of as H2O, one of skill would appreciate various ions, salts, minerals, impurities, and other substances (including at the ppb level) may be present in ‘water’. As used with respect to a chemical, unless specifically indicated otherwise, the singular includes all isomeric forms and vice versa (for example, “hexane”, includes all isomers of hexane individually or collectively).

The term “treatment” (or treating, treated, treat, etc.) as used herein may refer to an action or act such as purifying, reacting, transferring, separating, charging, heating, drying, cleaning, and so forth. One example may include ‘treating’ a multi-phase fluid to separate phases. Another example may include ‘treating’ a substantially aqueous (water) stream to remove a non-aqueous component. The act may be the result of an automated or manually controlled piece of equipment working separately or in combination with other components. The term ‘treatment’ may be analogous or equivalent to process(ing), handling, etc.

The term “microgas” as used herein may refer to the presence of a gas dispersed in a liquid resulting in bubbles. The term ‘microgas’ may be analogous or equivalent to ‘microbubbles’. Generally, the 95% of bubbles may have a diameter less than 100 microns. An average bulk density of bubbles may have a diameter less than 100 microns. The microbubbles may have an average bulk diameter less than 100 microns.

The term “ORP’ or “oxygen-reduction potential” as used herein may refer to a relationship or correlation to an amount of dissolved oxygen in water. High ORP for water means more environmentally sound water. When ORP is low, dissolved oxygen is low, toxicity of certain metals and contaminants may increase, and there is lots of dead and decaying material in the water that cannot be cleared or decomposed. Water for recycling generally desires a higher ORP on the magnitude of fresh water.

The term “agglomerate” as used herein may refer to an additive or constituent that may aid or facilitate the clumping of materials together into a floc, which may float to the top of a liquid (creaming), settle to the bottom of the liquid (sedimentation), or be readily filtered from the liquid. For example, water may have iron in the presence of 10 ppm to 100 ppm that may be agglomerated for removal. Iron may be charged with other chemistry to make it more attractive to an agglomerate.

The term “flash mixer” as used herein may refer to equipment or process step whereby a mixer is used to uniformly disperse and blend chemicals, such as coagulant aids, and the like, into a feed stream. These chemicals, either in solution or slurry form, may be added to aid in the removal of solids and other contaminants. The flash mixer may run with variable speed to ensure proper mixing to specification.

The term “tube settler” as used herein may refer to equipment or process step whereby one or more tubes (adjacent respective tubes) are used in a gravity separation process. The tubes are not limited to any particular shape, and may vary.

The term “NTU” or “nephelometric turbidity units” as used herein may refer to the amount of solids content in a fluid. The lower the NTU, the clearer the fluid (less solids present).

Embodiments herein may pertain to a process, system, etc. for processing a fluid in a manner that facilitates recycle, reuse, disposal, storage, etc. Any part or piece of equipment of systems, methods, processes, apparatus, etc. described herein may be operably configured to accomplish a desired result, regardless whether expressly indicated. For example, one ‘step’ may be coupled with another ‘step’, such as via fluid communication commonly accomplished via piping, tubing, etc. Any part or piece may have or be associated with sensors, gauges, valves, piping, control scheme, along with any necessary auxiliary equipment, such as pumps, heat exchangers, mixers, and the like. Any part or piece may include or be associated with a pressure vessel, a reactor, an atmospheric container, a storage tank, and the like. Any ‘stream’ may be or include a bypass, a branch (split), a recycle, and so forth, and may be single phase, multi-phase, slurry, solid, liquid, etc. Unless expressed or claimed otherwise, any embodiment herein may be batch, continuous, or combinations thereof.

Embodiments herein are a vast improvement upon the prior art by providing a user the ability to operate at a lower cost, greater contaminant removal efficiency, and without the risk of labor cleaning out the inside of these systems and the down time created by the clean out. Old systems are passive and require extensive periods of downtime.

Embodiments herein may be used for removal and management of oil and solids from water, and may further operate without chemicals for salt water disposal sites (SWD) and other facilities to efficiently capture the oil and remove the solids which can damage the disposal pumps and clog the disposal well. This preparation of the water for disposal is done without costly chemical additives. An automated control system may be used to manage levels, micro gas production, oil skimming and solids removal.

Embodiments herein may provide a user with ability to incorporate added treatment to react out remaining solids, specific metals and bacteria as required for recycled water for re-use in fracking and well completion. The control system may facilitate ability to (automatically) switch to a water recycling mode that may be required by the site. This allows one system to efficiently condition the water for disposal and from the touch of the operator screen, switch to generate water of a higher quality for reuse. This provides great value and flexibility in one line of equipment for the user. An oxidizer may be used in conjunction with a polymer to oxidize metals into oxides and agglomerate the solids to fall to the bottom of one or more tanks. The (automated) solids removal system along with the solids collection design of the tanks may provide for uninterrupted solids management. The oxidizer may be bleach, hydrogen peroxide, or the like.

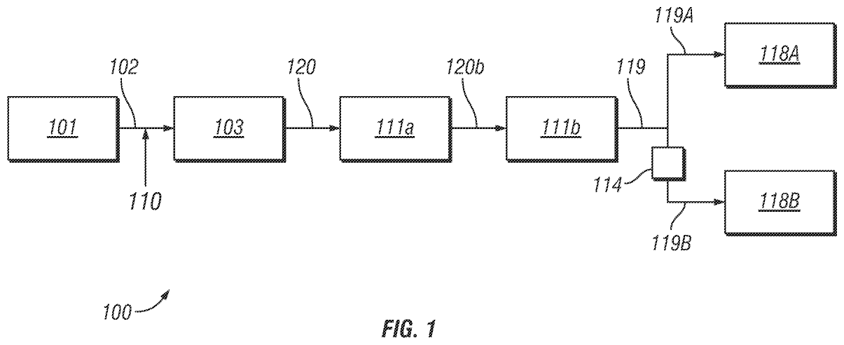

Referring now to FIG. 1, a simplified flow diagram of a process (or sometimes ‘system’) for treating a fluid, in accordance with embodiments disclosed herein, is shown. FIG. 1 illustrates a process 100 suitable for treating or processing a feed fluid 102 in a manner that results in forming or making a chemical product 119 (which may generally be in liquid form). The chemical product 119 may equivalently be referred to as ‘final product’, ‘treated product’, ‘product fluid’ ‘composition of matter’, and other comparable variations. The chemical product 119 may have a different specification, depending on the desired use or destination. For example, the chemical product 119 may have a first specification 119a suitable for a first destination 118a. The chemical product 119 may have a second specification 119b suitable for a second destination 118b. The second specification 119b may be quantified or characterized as being a tighter or more stringent specification.

### Preliminary Processing

Preliminary processing step 103 may include a treatment or pre-treatment process useable with the feed fluid 102. The feed fluid 102 may be an aqueous stream from a source 101, such as a pond, lake, tank, well, etc. The source 101 need not be next to the first processing step 103, and thus some amount of distance may be present (thus there may be transfer pumps and associated piping or the like). On the other hand, the source 101 be proximate to and/or part of the process 100.

The feed fluid 102 may be produced water, wastewater, brine, and so forth. The fluid 102 may be oily in that the stream may include a hydrocarbonaceous constituent. In a typical feed fluid 102, the hydrocarbonaceous constituent may be present in the range of 100 to 1000 ppm TPH (total petroleum hydrocarbon).

In the case of a waste stream, this type of oily-aqueous stream is notorious for a complete lack of usefulness in the industry. The feed fluid 102 may also include other contaminants, such as minerals, metals, and salts; these contaminants may be referred to as total dissolved solids or ‘TDS’. For example, there may be a range of 30,000 to 200,000 ppm TDS.

The processing step 103 may be a separation step, including physical or chemical separation, or in some instances a combination thereof, or other form of treatment. As the term ‘step’ is used herein, step may refer to a unit operation or other form of equipment (or operably connected pieces of equipment) suitable to perform the ‘step’.

As one example, the processing step 103 may include floatation (akin to dissolved air floatation [DAF]), which may be suitable to treat fluid 102 to remove suspended matter, such as oil or solids. Thus, the first processing step 103 may utilize a separation unit configured to facilitate floatation (or its operation thereof).

Although referenced as ‘air’ (including but not limited to atmospheric air), any type of gas may be used that results in synergy of some amount of desired floatation, but also some amount of remnant (but not permanent) diffusion into the feed fluid 102. For example, other gases such as natural gas (or methane), nitrogen, recycled or vented gas from process 100, or the like, may be used.

Smaller bubbles have a longer infusion within the fluid to create better adhesion to the oil particles. Larger bubbles may have reduced time within solution, and result in less efficient separation. It has been discovered that a microgas or microbubble solution having 95% or greater average bulk density bubble size in a bubble size range (by diameter) of 20 microns to 100 microns.

As such, removal of contaminants may occur by first dispersing a gas into a source of floatation liquid to form a solution having microbubbles 110 that may then be mixed or otherwise injected into the feed fluid 102. Within the processing step 103, the bubbles 110 may have a net charge that results in adhering to contaminants in the feed stream causing contaminants to float to the surface. This floated residue may then be removed by a skimming device or the like. Some amount of bulk average residence time may be of benefit.

The processing step 103 may result in a first treated fluid 120, which may generally be an aqueous stream with 85% to 99% TPH removal from the feed fluid 102.

There may also be a resultant byproduct or waste stream (not shown here). The waste stream may include some or most of the hydrocarbonaceous component that may be removable, whereby the stream may be reusable, but also discarded, vented, stored (for later sale or use), recycled, further treated or processed, etc.

### Secondary Processing

The first processing step 103 may be optional. In this respect, it may be the case that feed fluid 102 feeds directly to secondary processing 111 a and/or b. As described and shown here, the first treated fluid 120 (which could be the feed fluid 102), may be further processed, such as in a secondary processing step 111a. The first processing step 103 may be sufficient to remove certain constituents, while other undesired constituents remain in the treated fluid 120. For example, the first treated fluid 120 may have a higher-than-desired amount of metal (e.g., iron), which may be problematic.

It may be desirous to remove remnant constituents out of the treated fluid 120 or further process the treated fluid 120 to further specification, and thus in an analogous manner the secondary process step 111a may be used. Although not shown here, the first treated fluid 120 may be directed to an intermediate unit, such as a flash mixer, for blending with one or more additives.

In embodiments, the secondary processing step 111a may be or include clarification or other form of separation. The secondary processing step 111a may include a physical change to the fluid 120, a chemical change to the fluid 120, or combinations thereof. Whatever the case may be, the secondary processing step 111a may be used to create or result in a secondary treated fluid 120b. Secondary processing may further include secondary processing step 111b, which may be or include, for example, a (second) clarifier.

The secondary processing step 111b may result in a product fluid 119. As mentioned, the product stream may have an associated predetermined specification, depending on what use or destination the product fluid 119 will be directed to. The product fluid 119 may be transferred for further processing or interim storage, or sent out of the process 100, such as to a customer or waste disposal.

### Final Processing/Storage/Transfer

The product fluid 119 may be sent to a final destination or use. The process 100 may be used in a manner to be multifunctional, in that the process 100 may readily adjust (or ‘toggle’) [without having to stop or shutdown] to meet a different specification. This may be accomplished by the presence of a toggle or pivot skid 114, which facilitates the change in operation of the process. In operation, the product fluid 119 may have a first specification 119a suitable for transfer to first destination 118a. However, it may be desired to use the toggle skid 114 to adjust the product fluid 119 to a second specification 119b suitable for transfer to second destination 118b.

As the product fluid 119 may have greatly reduced solids, filtration may be used without causing a high burden to the filter cartridges. The toggle skid 114 may have equipment such as a pump, filter, sensors, valves, etc. to accommodate conforming the product fluid 119 to a tighter specification 119b compared to that of a lower specification 119a. When only a lower specification is needed, the toggle skid 114 may be off or deactivated, and thus bypassed or not used.

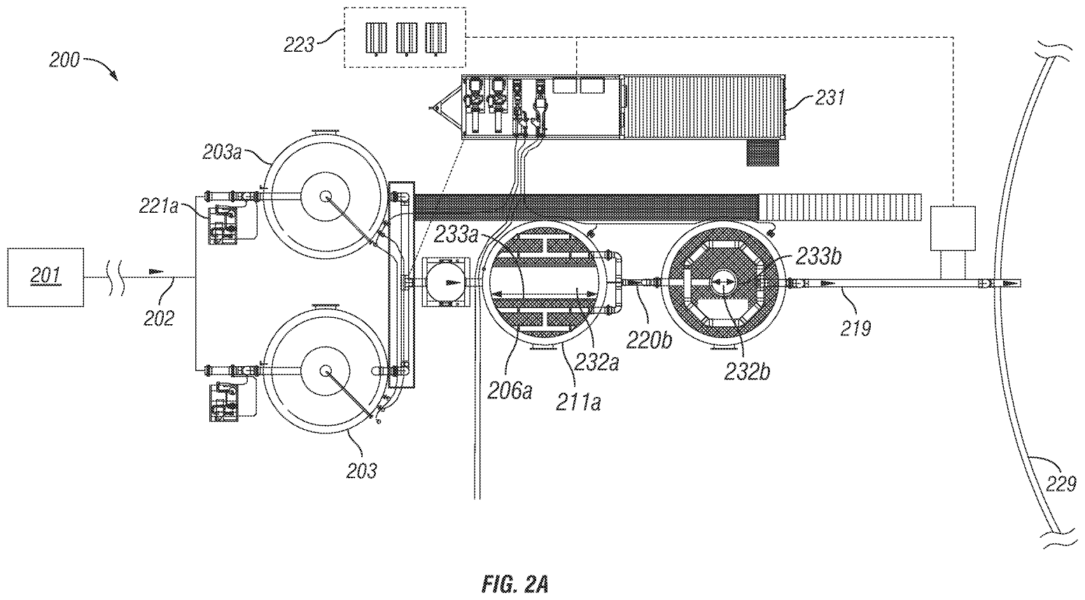

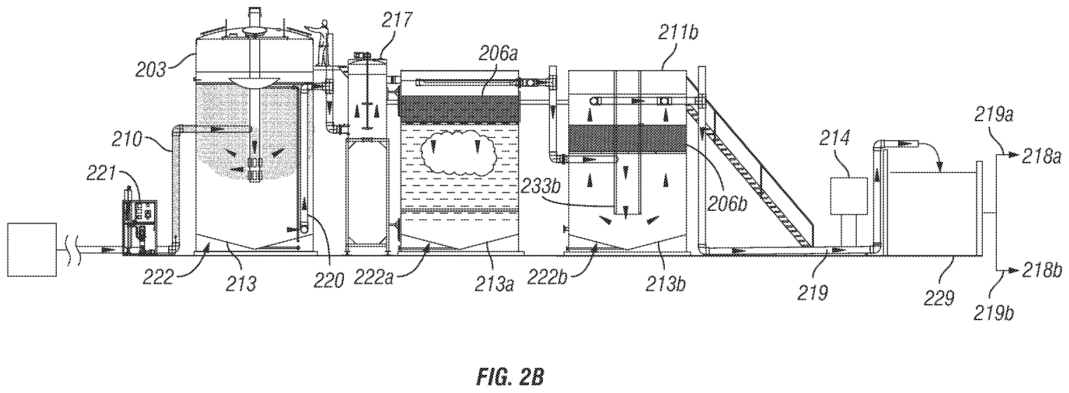

Referring now to FIGS. 2A and 2B together, an elevation overhead view of a unit operation diagram of a system for treating a fluid, and a side view of the unit operation diagram, respectively, in accordance with embodiments disclosed herein, are shown. FIGS. 2A and 2B illustrate a system 200 suitable for treating or processing a feed fluid 202 in a manner that results in forming or making a chemical product 219 (which may generally be in liquid form).

The chemical product 219 may equivalently be referred to as ‘final product’, ‘treated product’, ‘product fluid’ ‘composition of matter’, and other comparable variations. The chemical product 219 may have a different specification, depending on the desired use or destination. For example, the chemical product 219 may have a first specification 219a suitable for a first destination 218a. The chemical product 119 may have a second specification 219b suitable for a second destination 218b.

The second specification 219b may be quantified or characterized as being a tighter or more stringent specification than that of the first specification 219a. For example, it may be the case that the first specification 219a has a general requirement, such as for no more than 500 ppm total remnant hydrocarbon constituent(s) and/or no more than 100 ppm remnant solids. The second specification 219a may include any of the following: no more than 30 ppm remnant TPH; no more than 5 ppm total remnant iron-based constituent(s) (such as Fe, Fe2+, etc.); an ORP of at least 200 (positive); and/or a pH in a pH range of at least 6 to no more than 7.5. In aspects, the pH may be in the pH range of at least 6.9 to no more than 7.1. In other aspects, the ORP may be in the range of at least 200 (+) to no more than 350 (+).

A point to take note of then is that the system 200 is readily operable to rapidly toggle or pivot to provide a treated fluid with a changed specification requirement.

### Preliminary Processing

A preliminary processing or pretreatment unit 203 may be operable for treatment or pre-treatment process of the feed fluid 202. The feed fluid 202 may be an aqueous stream from a source 201, such as a pond, lake, tank, well, etc. The source 201 may be proximate to and/or part of the system 200.

The feed fluid 202 may be produced water, wastewater, brine, and so forth. The fluid 202 may be oily in that the stream may include a hydrocarbonaceous constituent. In a typical feed fluid 202, the hydrocarbonaceous constituent may be present in the range of 100 to 1000 ppm TPH (total petroleum hydrocarbon). In the case of a waste stream, this type of oily-aqueous stream is notorious for a complete lack of usefulness in the industry.

The feed fluid 102 may also include other contaminants, such as minerals, metals, and salts; these contaminants may be referred to as total dissolved solids or ‘TDS’. For example, there may be a range of 30,000 to 200,000 ppm TDS. The processing unit 203 may be a separation unit, such as an oil-water separator, configured and operable to provide a physical or chemical separation, or in some instances a combination thereof, or other form of treatment.

The preliminary processing unit 203 may receive the feed fluid 202 that is overly emulsified with oil and other contaminants, and thus a standard gravity-type separation may be ineffective. As such, the processing of the feed fluid 202 may require an additional boost or kick to drive separation.

As one example, the processing unit 203 may include floatation (akin to dissolved air floatation [DAF]), which may be suitable to treat fluid 203 to remove suspended matter, such as oil or solids. Thus, the unit 203 may be a separation unit configured to facilitate floatation (or its operation thereof). Although referenced as ‘air’ (including but not limited to atmospheric air), any type of gas may be used that results in an infusion effect with the feed fluid 202, including nitrogen, natural gas, field gas, recycled gas, and the like.

On the one hand it may be the case that a larger gas bubble (diameter) is desired in order to provide the float effect; however, for embodiments herein it may not be the case, as instead, greater retention time within the unit 203 may be beneficial, and thus a smaller gas bubble is desired.

Removal of contaminants may occur by first dispersing a gas into a source of floatation liquid to form a solution having microbubbles 210 that may then be mixed or otherwise injected into the feed fluid 202. The unit 203 may be operably coupled with a microgas unit 221. The microgas unit 221 may include various equipment, such as valve, pump, etc. to create a gaseous solution.

Although not shown in detail here, the gas unit 221 may include a pump operable to draw a liquid (which may come from unit 203) and increase pressure through a valve and vacuum transducer that results in a controlled vacuum to the pump inlet. This may then allow gas (e.g., air) to be drawn into the liquid. The resultant gas solution may be pumped into a microgas tank (generally about 100 psi). The outbound flow from the tank may be regulated so that a desired amount of the solution may be mixed to the feed fluid. Any undesired buildup within the tank may be vented.

The operation of the microgas unit 221 may be suitable to control or determine bubble size within the solution. Generally, the bubble size may be sub-100 micron. In embodiments, the microbubbles 210 may have 95% bubbles with a diameter less than 100 micron. In embodiments, the microbubbles 210 may have 95% bubbles with a diameter in a range of 20 microns to 100 microns. In other embodiments, there may be 95% bubbles with a diameter in a range of 30 microns to 50 microns. It may be desirous to have a bubble of some size to provide a lifting effect and thus not too small that the gas is completely infused into the feed fluid 202. In the event of nanobubbles or smaller, there may not be adequate lifting and separation in the unit 203.

Within the unit 203, the bubbles 210 may have a net charge that results in adhering to contaminants in the feed fluid 202 causing contaminants to float to the surface. This floated residue may then be removed by a skimming device or the like. Some amount of bulk average residence time may be of benefit. Normal range of feed through the system 200 may be 20,000 bpd to 40,000 bpd through the system. Bulk average residence time of the feed fluid in the unit 203 may be about 30 minutes to 60 minutes.

The separation unit 203 may result in a first treated stream 220, which may generally be an aqueous stream with 85% to 99% TPH removal from the feed fluid 202. There may also be a resultant byproduct or waste stream (not shown here). The waste stream may include some or most of the hydrocarbonaceous component that may be removable, whereby the stream may be reusable, but also discarded, vented, stored (for later sale or use), recycled, further treated or processed, etc.

As shown here the system 200 may include a second separation unit 203a, which may be operable in parallel, thus providing redundancy to the system in the event of a maintenance issue or other contingency. The second separation unit 203a may be operable in the same or similar manner as the unit 203.

### Secondary Processing

The separation unit 203 may be sufficient to remove certain constituents from the feed fluid 202, while other undesired constituents remain in the treated fluid 220. For example, the first treated fluid 220 may have a higher-than-desired amount of metal (e.g., iron), which may be problematic. As described and shown here, the first treated fluid 220 (which could be the feed fluid 202), may be further processed, such as in a secondary processing unit 211a.

It may be desirous to remove remnant constituents out of the treated stream 220 or further process the treated stream 220 to further specification. Prior to the secondary unit 211a, the first treated fluid 220 may thus be directed to an intermediate unit 217 or intermediate, such as a flash mixer, for blending with one or more additives.

The mixer 217 may be a flash mixer to accommodate rapid blending of the treated fluid 220 with one or more additives provided from additive skid 223. Example additives may include an oxidizer, an agglomerate, a polymer, and the like. The oxidizer may be bleach, hydrogen peroxide, or the like.

The use of additives may depend on the desired destination specification 219a, 219b, etc. A control skid 231 may be configured with pumps, metering, etc. operable to transfer and control additive feed from the skid 223 to the first treated fluid 220. Just the same, if additives are unnecessary, the treated fluid 220 may bypass or pass through the mixer 217.

In embodiments, the system 200 may include a first clarifier 211a. The first clarifier 211a may be operable to create or result in a secondary treated fluid 220b. The secondary treated fluid 220b may then be transferred to a second clarifier 211b, which may be operable in series to the first clarifier 211a. The second clarifier 211b may be operable to result in or crate the product fluid 219.

Of significance here is that the downstream equipment from the first separation unit 203 is not just static flat bottom tanks. Instead, there may be an active and dynamic operation through units 203, 211a, 211b. Conventionally, static flat bottom tanks become laden with sediment that requires periodic and frequent cleaning.

As shown here, the units 203, 211a, 211b may have elevated or sloped bottoms, respectively, 213, 213a, 213b. These surfaces may have an associated angle 222, 222a, 222b to a surface (horizontal) or reference axis. This type of configuration may facilitate improved solids management and handling, and all but eliminate expensive solids maintenance. For example, remnant solids will naturally flow to a bottom-most point within the units, which may then be drawn off for removal via piping and solids pump (not viewable here).

The operation and configuration of the clarifiers 211a, 211b may be in a manner to further drive separation. For example, the first clarifier 211a may be configured with a larger first feed zone 232a than that of a smaller second feed zone 232b of the second clarifier 211b. The first feed zone 232a may be configured and useful to provide a degasification function to the treated fluid 220.

The first clarifier 211a may have one or more partitions or baffles 233a that force fluid feed downward in the feed zone 232a, and outward to the side. The baffle(s) 233a may extend laterally from one sidewall of the clarifier 211a to an opposite sidewall thereof. As the treated fluid 220 flows downward in the feed zone 232a, and then back up against the sidewall, the fluid may come into contact with a layer of packing 206a. The packing 206a may be tubular packing or promote tubular settling. This type of packing 206a is not of use in the oilfield industry, as it is known readily plug and foul as a result of oil.

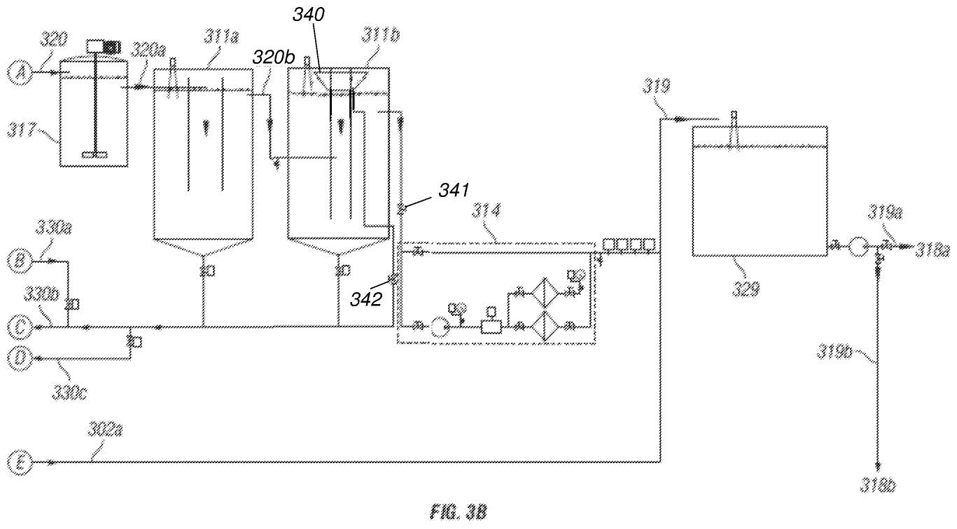

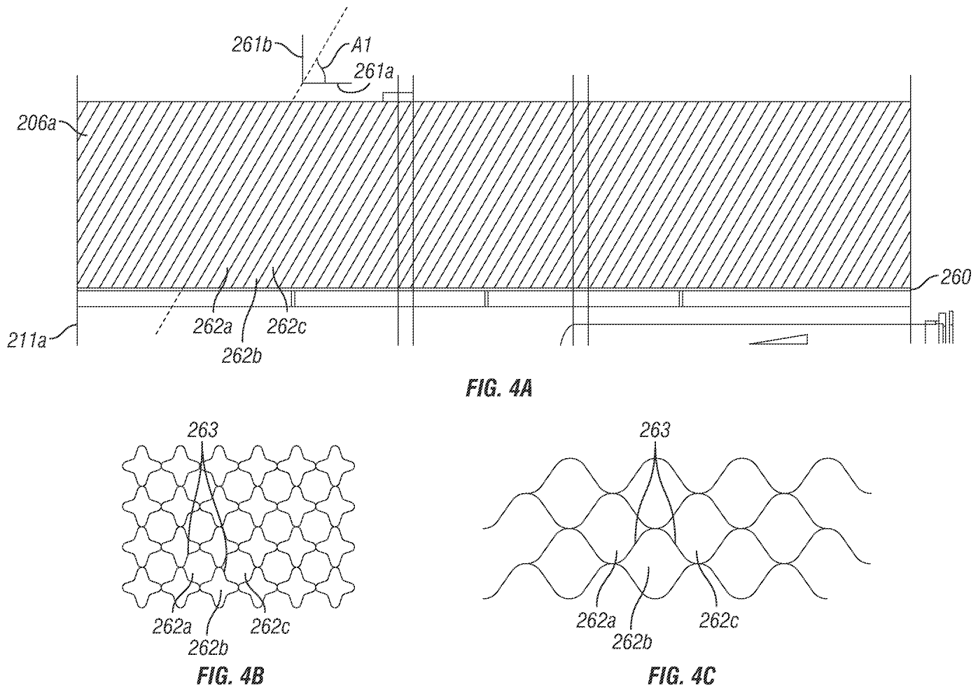

Referring briefly to FIGS. 4A, 4B, and 4C, a close-up side cross-sectional view of a bed or stage of tubular packing, a downward lateral cross-sectional view of an example of a tube cell configuration, and a downward lateral cross-sectional view of another example of a tube cell configuration, respectively, in accordance with embodiments disclosed herein, are shown.

FIG. 4A shows a layer of packing 206a that may be used with one or more units of the disclosure, such as the first clarifier 211a. The layer of packing 206a need not be limited to the example shown in FIG. 4A, and thus have other configuration embodiments. Generally, the packing may be supported by support or beam 260. The packing 206a may be tubular packing, such that there are a plurality of channels 262a, 262b, 262c.

The packing 206a may include tubular-type structure oriented at an angle A1 with respect to a reference or axis 261a, 261b. The structure of the packing 206a may be based upon placement of multiple corrugated sheets next to each other. FIGS. 4B and 4C illustrate examples of sidewalls 263 coupling together to form the plurality of channels 262a, 262b, 262c, etc. Other configurations are possible, including more than one layer.

Generally, the packing may have a tubular cross section of approximately 4 square inches with the tubular bundles to be approximately upwards of 40 inches high and arranged to cover the surface of the tank within the upward flow section. The tubular sections may at an angle to the vertical. For example, the angle may be about 30 degrees to about 60 degrees down from the vertical plane. The packing may be a durable material, such as made from PVC or polypropylene plastic. The packing may be held in place, such as mechanically held in place. The packing may be made from a plastic with a density greater than water to hold in place.

Referring again to FIGS. 2A and 2B, from the first clarifier 211a a secondary treated fluid 220b may be transferred and fed to the second clarifier 211b. Of significance, the second clarifier 211b may have a different internal configuration. For example, the feed zone 232b may be smaller. Moreover, the baffle 233b need not extend into contact with a sidewall of the clarifier 211b, and may thus be a feed tube-shape or the like.

Flow into the second feed zone 232b may be downward out of the feed tube 233b, and upward along the sides of the clarifier 211b. The upward flow may come into contact with a respective layer of packing 206b. The packing 206b may be tubular packing or promote tubular settling.

From the second clarifier 211b, the product fluid 219 may be transferred to intermediate storage tank 229. As mentioned, the product fluid 219 may have an associated predetermined specification, depending on what use or destination the product fluid 219 will be directed to. The product fluid 219 may be transferred for further processing or interim storage, or sent out of the system 200, such as to a customer or waste disposal.

### Final Processing/Storage

The product fluid 219 may be sent to a final destination or use. The system 200 may be used in a manner to be multifunctional, in that the system 200 may readily adjust (or toggle, pivot, etc.) [without having to stop or shutdown] to meet a different specification. This may be accomplished by the presence of a toggle skid 214, which facilitates the change in operation of the system. In operation, the product fluid 219 may have a first specification 219a suitable for transfer to first destination 218a. However, it may be desired to use the toggle skid 214 to adjust the product fluid 219 to a second specification 219b suitable for transfer to second destination 218b.

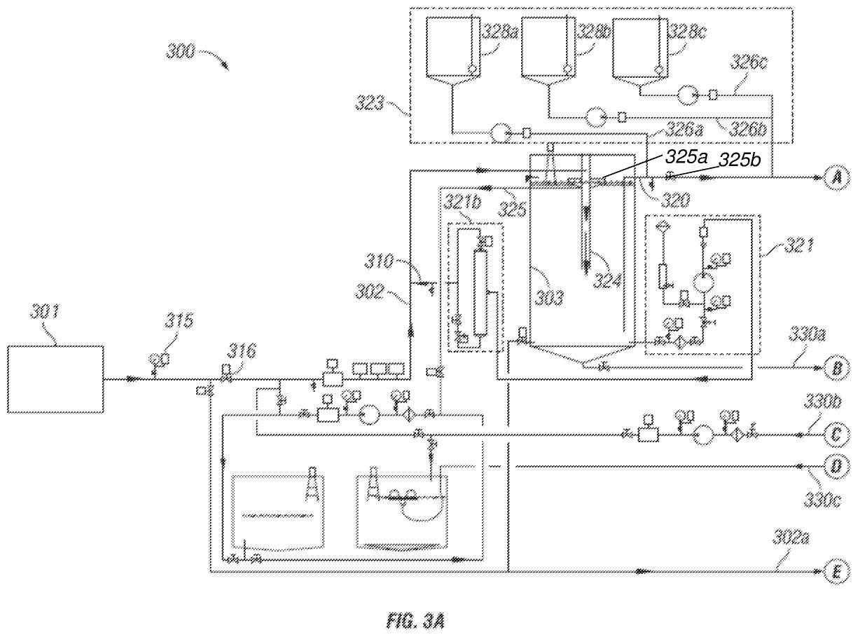

As the product fluid 219 may have greatly reduced solids, filtration may be used without causing a high burden to the filter cartridges. Although not shown in detail here, the toggle skid 214 may have equipment such as a pump, filter, sensors, valves, etc. to accommodate conforming the product fluid 219 to a tighter specification 219b compared to that of a lower specification 219a (see FIGS. 3A, 3B for a more detailed example). When only a lower specification is needed, the toggle skid 214 may be off or deactivated, and thus bypassed or not used. The toggle skid 214 may be in operable communication with the control skid 231.

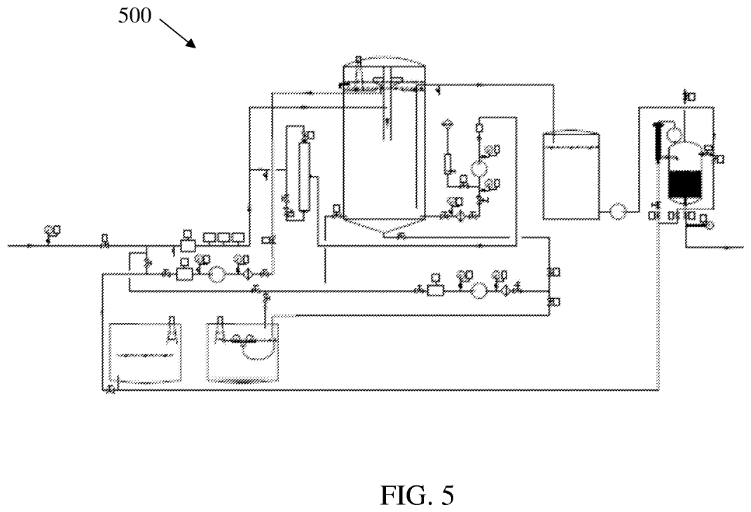

Referring briefly to FIG. 5, a system for treating a fluid that utilizes a zeolite filtration process in accordance with embodiments disclosed herein, is shown. FIG. 5 shows a system 500 like that of embodiments described herein. Redundant or comparable features, equipment, etc. need not be discussed in great detail, but would be discernable to one of skill in the art via other system description (200, 300, etc.). To improve or enhance oil separation process (with the Microgas) it may be desirous to add a nutshell or modified zeolite filtration process. The use of such a filtration process may be able to further remove remaining oil to less than 10 PPM and/or remove fine solids. This may be very desirable at an SWD or or other applications which are needing very low oil and solids. This can also be targeted at lithium extraction, chemical recovery and production and other such application.

Embodiments may use an oleophilic media, which may be periodically turbulated by a mix pump or up flow to drive off the oil and solids to regenerate the semi-permanent media. FIG. 5 illustrates a system 500 having this inserted into the system flow. Using this technology with the microgas process adds an additional level of performance.

Referring now to FIGS. 3A and 3B together, a block flow diagram of a front-end portion of a system for treating a fluid, and a back-end portion of the system of FIG. 3A, respectively, in accordance with embodiments disclosed herein, are shown. FIGS. 3A and 3B illustrate a system 300 suitable for treating or processing a feed fluid 302 in a manner that results in forming or making a chemical product 319 (which may generally be in liquid form).

The chemical product 319 may equivalently be referred to as ‘final product’, ‘treated product’, ‘product fluid’ ‘composition of matter’, and other comparable variations. The chemical product 319 may have a different specification, depending on the desired use or destination. For example, the chemical product 319 may have a first specification 319a suitable for a first destination 318a. The chemical product 319 may have a second specification 319 suitable for a second destination 318b.

The second specification 319b may be quantified or characterized as being a tighter or more stringent specification than that of the first specification 319a. For example, it may be the case that the first specification 319a has a general requirement, such as for no more than 500 ppm total remnant hydrocarbon constituent(s) and/or no more than 100 ppm remnant solids. The second specification 319a may include one or more of the following: no more than 30 ppm remnant TPH; no more than 5 ppm total remnant iron-based constituent(s) (such as Fe, Fe2+, etc.); an ORP of at least 200 (positive); and/or a pH in a pH range of at least 6 to no more than 7.5. In aspects, the pH may be in the pH range of at least 6.9 to no more than 7.1. In other aspects, the ORP may be in the range of at least 200 (+) to no more than 350 (+).

### Preliminary Processing

System 300 may have various pumps, piping, etc., operably configured with instrumentation 315 and valves 316, as would be appreciated by one of skill in the art. The system 300 may have a control or automation associated with it. The system 300 may operate in batch, continuous, or in hybrid operation thereof.

A preliminary processing or pretreatment unit 303 may be operable for treatment or pre-treatment process of the feed fluid 302. The feed fluid 302 may be an aqueous stream from a source 301, such as a pond, lake, tank, well, etc. The source 301 may be proximate to and/or part of the system 300.

The feed fluid 302 may be produced water, wastewater, brine, and so forth. The fluid 302 may be oily in that the stream may include a hydrocarbonaceous constituent. In a typical feed fluid 302, the hydrocarbonaceous constituent may be present in the range of 100 to 1000 ppm TPH (total petroleum hydrocarbon). In the case of a waste stream, this type of oily-aqueous stream is notorious for a complete lack of usefulness in the industry.

The feed fluid 302 may also include other contaminants, such as minerals, metals, and salts; these contaminants may be referred to as total dissolved solids or ‘TDS’. For example, there may be a range of 30,000 to 200,000 ppm TDS. The processing unit 303 may be a separation unit, such as an oil-water separator, configured and operable to provide a physical or chemical separation, or in some instances a combination thereof, or other form of treatment.

The preliminary processing unit 303 may receive the feed fluid 303 that is emulsified with oil and other contaminants, and thus a standard gravity-type separation may be ineffective. As such, the processing of the feed fluid 302 may require an additional boost or kick to drive separation.

As one example, the processing unit 303 may include floatation (akin to dissolved air floatation [DAF]), which may be suitable to treat fluid 302 to remove suspended matter, such as oil or solids. Thus, the unit 303 may be a separation unit configured to facilitate floatation (or its operation thereof). Removal of contaminants may occur by first dispersing a gas into a source of floatation liquid to form a solution having microbubbles 310 that may then be mixed or otherwise injected into the feed fluid 302. The unit 302 may be operably coupled with a microgas unit 321. The microgas unit 321 may include various equipment, such as valve, pump, etc. to create a gaseous solution.

Although not shown in detail here, the gas unit 321 may include a pump operable to draw a liquid (which may come from unit 303) and increase pressure through a valve and vacuum transducer that results in a controlled vacuum to the pump inlet. This may then allow gas (e.g., air) to be drawn into the liquid. The resultant gas solution may be pumped into a microgas tank 321b (generally about 100 psi). The outbound flow from the tank 321b may be regulated so that a desired amount of the solution may be mixed to the feed fluid 302. Any undesired buildup within the tank 321b may be vented.

The operation of the microgas unit 321 may be suitable to control or determine bubble size within the solution. Generally, the bubble size may be sub-100 micron. In embodiments, the microbubbles 321 may have 95% bubbles with a diameter less than 100 micron. In embodiments, the microbubbles 210 may have 95% bubbles with a diameter in a range of 20 microns to 100 microns. In other embodiments, there may be 95% bubbles with a diameter in a range of 30 microns to 50 microns. It may be desirous to have a bubble of some size to provide a lifting effect and thus not too small that the gas is completely infused into the feed fluid 302. In the event of nanobubbles or smaller, there may not be adequate lifting and separation in the unit 303.

Within the unit 303, the bubbles 310 may have a net charge that results in adhering to contaminants in the feed fluid 302 causing contaminants to float to the surface. This floated residue 325 may then be removed by a skimming device or the like, and send to storage or further treatment. Some amount of bulk average residence time may be of benefit. Normal range of feed through the system 300 may be 20,000 bpd to 40,000 bpd through the system. Bulk average residence time of the feed fluid in the unit 303 may be about 30 minutes to 60 minutes.

The feed fluid 302 may be fed in a downward direction 324 via a feed tube disposed in the unit 303. Operation of the separation unit 303 may result in a first treated stream 320, which may generally be an aqueous stream with 85% to 99% TPH removal from the feed fluid 302. The treated stream 320 may be drawn from the unit 303 from a lower or bottom portion thereof.

The floated residue 325 be a resultant byproduct or waste stream. The waste stream 325 may include some or most of the hydrocarbonaceous component that may be removable, whereby the stream may be reusable, but also discarded, vented, stored (for later sale or use), recycled, further treated or processed, etc.

There may be a skimming dish 325a disposed on the tank 303 (such as at the top). This dish 325a may sit above the normal operation level of the tank 303, such as in a range of 6 inches to about 10 inches. In embodiments, the height above normal level may be about 8 inches. On an occasion or periodic interval, and as may be controlled by the systems controls, which may be activated by an oil sensor sensing the target level of oil to actuated valve 325b may be closed such that the tank level may rise. Once the tank level control realizes (measures) the level rise above the rim of the dish 325a, an actuated valve on line 325 may be opened, and the actuated valve 325b may be opened.

The operation of the suction pump on line 325 may draw the oil and solids from the dish to the oil tank. The tank level may drop back down to the normal running condition. This process can be repeated several times by the systems controls and may be done on an adjustable interval to prevent oil buildup. There may be a solids or slurry 330a continually or as desired removed from the unit 303.

Although not shown here, the system 300 may include a second separation unit, which may be operable in parallel, thus providing redundancy to the system in the event of a maintenance issue or other contingency. To that end, the system 300 is not limited, and other separation units or trains may be used. It should be noted that some or all of the feed 302 may be directed as a bypass flow 302a to the back end of the system 300, thus without need for processing within unit 303.

### Secondary Processing

The separation unit 303 may be sufficient to remove certain constituents from the feed fluid 302, while other undesired constituents remain in the treated fluid 320. For example, the first treated fluid 320 may have a higher-than-desired amount of metal (e.g., iron), which may be problematic. As described and shown here, the first treated fluid 320 (which could be the feed fluid 302), may be further processed, such as in a secondary processing unit 311a.

It may be desirous to remove remnant constituents out of the treated stream 320 or further process the treated stream 320 to further specification. Prior to the secondary unit 311a, the first treated fluid 320 may thus be directed to an intermediate unit 317, such as a flash mixer, for blending with one or more additives.

The mixer 317 may be a flash mixer to accommodate rapid blending of the treated fluid 320 with one or more additives provided from additive skid 323. Example additives 326a, 326b, 326c may include an oxidizer, an agglomerate, a polymer, and the like. There may be one or more respective additive feed sources 328a, 328b, 328c, etc. The additives from the respective sources 328a, 328b, 328c may be mixed directly into the treated stream 320, or may be mixed with one another prior to mixing into the treated stream 320, as may be desired.

The use of additives 326 a, b, c may depend on the desired destination specification 319a, 319b, etc. A control skid 331 may be configured with pumps, metering, etc. operable to transfer and control additive feed from the skid 232 to the first treated fluid 320. Just the same, if additives are unnecessary, the treated fluid 320 may bypass or pass through the mixer 317. Thus, intermediate mixed fluid 320a may or may not include additives.

In embodiments, the system 320 may include a first clarifier 311a. The first clarifier 311a may be operable to create or result in a secondary treated fluid 320b. The secondary treated fluid 320b may then be transferred to a second clarifier 311b, which may be operable in series to the first clarifier 311a. The second clarifier 311b may be operable to result in or crate the product fluid 319.

Of significance here is that the downstream equipment from the first separation unit 303 is not just static flat bottom tanks. Instead, there may be an active and dynamic operation through units 303, 311a, 311b that may include removal of solids or slurry 330a, 330b, 330c. This type of configuration may facilitate improved solids management and handling, and all but eliminate expensive solids maintenance. For example, remnant solids will naturally flow to a bottom-most point within the units, which may then be drawn off for removal via piping and respective solids pump(s).

From the first clarifier 311a the secondary treated fluid 320b may be transferred and fed to the second clarifier 311b. Of significance, the second clarifier 311b may have a different internal configuration than first clarifier 311a.

From the second clarifier 311b, the product fluid 319 may be transferred to intermediate storage tank or destination 329. As mentioned, the product fluid 319 may have an associated predetermined specification, depending on what use or destination the product fluid 319 will be directed to. The product fluid 319 may be transferred for further processing or interim storage, or sent out of the system 300, such as to a customer or waste disposal.

### Final Processing/Storage

The product fluid 319 may be sent to a final destination or use. The system 300 may be used in a manner to be multifunctional, in that the system 300 may readily adjust (or toggle, pivot, etc.) [without having to stop or shutdown] to meet a different specification. This may be accomplished by the presence of a toggle skid 314, which facilitates the change in operation of the system. In operation, the product fluid 319 may have a first specification 319a suitable for transfer to first destination 318a. However, it may be desired to use the toggle skid 314 to adjust the product fluid 319 to a second specification 319b suitable for transfer to second destination 318b.

During recycling an oxidizer may be used as part of the chemical treatment. The oxidizer may be bleach, hydrogen peroxide, or the like. The oxidation of the high iron content of the water may cause the iron solids to float to the surface the oxidizer. A skimming dish 340 may be installed in the tank 311b (such as at or proximate the top).

This dish 340 may sit at a height above the normal operation level of the tank 311b. For example, the height may be about 6 inches to about 10 inches. In embodiments, the dish may sit approximately 8 to 12 inches above the normal operation level of the tank 311b. On a periodic interval, which may be manual or controlled by the systems controls, the second step actuated valve 341 may be closed, which may thus allow the tank level to rise.

Once the tank level controls detect the level rise above the rim of the suction dish, actuated valve 341 may be opened and another actuated valve 342 opened and the operation of the suction pump on line 330b draws the solids from the dish to the solids tank. The tank level may then drop back down to the normal running condition. This process may be repeatable, and may be accomplished via systems controls. It may also be done on an adjustable interval to prevent tank buildup.

As the product fluid 319 may have greatly reduced solids, filtration may be used without causing a high burden to the filter cartridges. The toggle skid 314 may have equipment such as a pump, filter, sensors, valves, etc. to accommodate conforming the product fluid 319 to a tighter specification 319b compared to that of a lower specification 319a. When only a lower specification is needed, the toggle skid 314 may be off or deactivated, and thus bypassed or not used. The toggle skid 314 may be in operable communication with the control skid 331.

The system may include oil skim dish automation. This configuration may substantially or completely remove the pad buildup that takes place in conventional oil water separators. Pad may be understood as a floating mat created from oil, iron oxide and other floating materials that builds into a semi solids mass, if not removed on a routine basis. There may be solids skim dish automation, such as on tank 311b.

There may be a dual system design for producing high quality water, removing higher amount of oil and solids for disposal and with the same system, from the touch screen convert to recycling water operation.

### Advantages

Embodiments herein may provide for a multi-tank design for optimized oil and solids separation. There may be one or more tanks (such as an oil-water separation OWS), which may have a non-planar or unflat bottom. There may be a conical bottom, with 15 degree or greater slope to aid automatic solids suction removal on a time-controlled interval.

Embodiments herein may advantageously provide for a microbubble (or sometimes ‘microgas’) system to <100 micron bubbles into a feed stream of the OWS with the influent flow to agglomerate and lift the oil particles. Gas may be induced in a vacuum on the inlet side of the pump, to generate charged micro gas. This gas can be atmospheric air, nitrogen, or other available gas sources.

There may be a vertical OWS tank design with center feed pipe for gas distribution and flow stabilization. Downstream tanks in series may be used to create added separation. These tanks may have one or more separation zones that may be combined with cone bottoms, all of which may be integrated into the automated solids suction system. Advantageously, the thank(s) may have a center stilling well and separation packing used for stabilized solids removal. This may provide for a cascading, gravity flow through, which may eliminate transfer pumps and their operating costs.

A mixer tank (such as a flash mixer) may be incorporated in-line downstream of the OWS tank. The mixer tank may be used for the introduction and controlled blending of additives, such as an oxidizer, a polymer, etc. This may be accomplished for a recycled water operation. The blending speed may be controlled to scale with the influent flow rate to not over or under blend the chemical additives.

Yet other aspects of the disclosure may advantageously pertain to a complete lack of electrocoagulation, chemical dissolved air floatation systems and/or membrane-type separation. Cost savings from smaller footprint, less complications, less labor, less chemistry, less capital investment.

While embodiments of the disclosure have been shown and described, modifications thereof can be made by one skilled in the art without departing from the spirit and teachings of the disclosure. The embodiments described herein are exemplary only and are not intended to be limiting. Many variations and modifications of the disclosure presented herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of any claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A process for treating a feed fluid in a manner that results in a product fluid, the process comprising:
providing the feed fluid to a first treatment step, the feed fluid being aqueous and comprising a hydrocarbonaceous constituent present in the range of 100 to 1000 ppm total petroleum hydrocarbon;
prior to the first treatment step, injecting a gas solution into the feed fluid, the gas solution having gas bubbles with an average bulk diameter of less than 100 microns;
treating the feed fluid with the injected gas solution via the first treatment step to produce a first treated stream; and
providing the first treated stream to a second treatment step.

2. The process for treating a fluid of claim 1, wherein the first treated stream comprises an aqueous stream with 85% to 99% total petroleum hydrocarbon removal from the feed fluid.

3. The process for treating a fluid of claim 1, wherein the source fluid comprises produced water, wastewater, brine, and combinations thereof, wherein prior to the second treatment step an additive is mixed with the first treated stream, and wherein the additive comprises one of an oxidizer, an agglomerate, a polymer, and combinations thereof.

4. The process for treating a fluid of claim 1, wherein the second treatment step results in the product fluid comprising: no more than 30 ppm remnant total petroleum hydrocarbon; no more than 5 ppm total remnant iron-based constituent(s); a pH in a pH range of at least 6 to no more than 7.5; and an ORP in the range of at least 200 (+) to no more than 350 (+).

5. The process for treating a fluid of claim 1, wherein the first treatment step further comprises operating a separation unit to provide a bulk fluid residence time of at least 30 minutes to no more than 60 minutes.

6. The process for treating a fluid of claim 1, wherein the first treatment step comprises using a tank configured with a skimming dish, wherein the skimming dish is disposed above a normal operation level of the tank, wherein after a period of time a valve on a discharge line from the tank is closed so that the tank level rises above the rim of the dish.

7. The process for treating a fluid of claim 1, wherein the second treatment step further comprises operating a clarifier with a layer of tubular packing, and the clarifier is configured with a skimming dish, wherein the skimming dish is disposed above a normal operation level of the clarifier, wherein after a period of time a valve on a discharge line from the tank is closed so that a liquid level rises above a rim of the dish.

8. A process for treating a feed fluid in a manner that results in a product fluid, the process comprising:
providing the feed fluid to a first treatment step, the feed fluid being aqueous and comprising a hydrocarbonaceous constituent present in the range of 100 to 1000 ppm total petroleum hydrocarbon;
prior to the first treatment step, injecting a gas solution into the feed fluid, the gas solution having gas bubbles with an average bulk diameter in a bubble size range of at least 20 microns to no more than 100 microns;
treating the feed fluid with the injected gas solution via the first treatment step to produce a first treated stream; and
providing the first treated stream to a second treatment step,
wherein the first treated stream comprises an aqueous stream with 85% to 99% total petroleum hydrocarbon removal from the feed fluid.

9. The process for treating a fluid of claim 8, wherein the product fluid comprises: no more than 30 ppm remnant total petroleum hydrocarbon; no more than 5 ppm total remnant iron-based constituent(s); a pH in a pH range of at least 6 to no more than 7.5; and an ORP in the range of at least 200 (+) to no more than 350 (+).

10. The process for treating a fluid of claim 9, wherein the first treatment step further comprises operating a separation unit to provide a bulk fluid residence time of at least 30 minutes to no more than 60 minutes.

11. The process for treating a fluid of claim 10, wherein prior to the second treatment step an additive is mixed with the first treated stream, and wherein the additive comprises one of an oxidizer, an agglomerate, a polymer, and combinations thereof.

12. The process for treating a fluid of claim 11, wherein the second treatment step further comprises operating a clarifier with a layer of tubular packing.

13. The process for treating a fluid of claim 1, the process further comprising using a modified zeolite or walnut shell media filtration process in order to further remove remaining oil to less than 10 PPM and remove fine solids.

14. The process for treating a fluid of claim 13, wherein using the modified zeolite filtration process further comprises using an oleophilic media or walnut shell media that is periodically turbulated by a mix pump or up flow to drive off the oil and solids to regenerate a semi-permanent media.

15. A process for treating a feed fluid in a manner that results in a product fluid, the process comprising:
providing the feed fluid to a first treatment step, the feed fluid being aqueous and comprising a hydrocarbonaceous constituent present in the range of 100 to 1000 ppm total petroleum hydrocarbon;
prior to the first treatment step, injecting a gas solution into the feed fluid, the gas solution having gas bubbles with an average bulk diameter in a bubble size range of at least 20 microns to no more than 100 microns;
treating the feed fluid with the injected gas solution via the first treatment step to produce a first treated stream; and
providing the first treated stream to a second treatment step,
wherein the first treated stream comprises an aqueous stream with 85% to 99% total petroleum hydrocarbon removal from the feed fluid, and
wherein the second treatment step further comprises operating a clarifier with a layer of tubular packing.

16. The process for treating a fluid of claim 15, wherein the product fluid comprises: no more than 30 ppm remnant total petroleum hydrocarbon; no more than 5 ppm total remnant iron-based constituent(s); a pH in a pH range of at least 6 to no more than 7.5; and an ORP in the range of at least 200 (+) to no more than 350 (+), and
wherein the first treatment step further comprises operating a separation unit to provide a bulk fluid residence time of at least 30 minutes to no more than 60 minutes.

17. The process for treating a fluid of claim 16, wherein the source fluid comprises produced water, waste water, brine, and combinations thereof, wherein prior to the second treatment step an oxidizer is mixed with the first treated stream, and wherein the oxidizer comprises one of bleach, hydrogen peroxide, and combinations thereof

18. The process for treating a fluid of claim 15, wherein the source fluid comprises produced water, waste water, brine, and combinations thereof, and wherein the first treatment step further comprises operating a separation unit to provide a bulk fluid residence time of at least 30 minutes to no more than 60 minutes

19. The process for treating a fluid of claim 15, wherein the tubular packing is configured at an angle to a reference axis in a range of at least 30 degrees to no more than 60 degrees.

20. The process for treating a fluid of claim 15, wherein the first treatment step comprises using a tank configured with a skimming dish, wherein the skimming dish is disposed above a normal operation level of the tank, wherein after a period of time a valve on a discharge line from the tank is closed so that the tank level rises above the rim of the dish, wherein the second treatment step further comprises operating a clarifier with a layer of tubular packing, and the clarifier is configured with a respective skimming dish, wherein the respective skimming dish is disposed above a normal operation level of the clarifier, wherein after a period of time a respective valve on a discharge line from the clarifier is closed so that a liquid level rises above a rim of the respective skimmer dish.
